(19) United States
(12) Patent Application Publication
(10) Pub. No.: US 2002/0101362 A1
(43) Pub. Date: Aug. 1, 2002

(54) Backup traffic control in the event of power failure

(76) Inventor: Ken A. Nishimura, Fremont, CA (US)

Correspondence Address: AGILENT TECHNOLOGIES, INC., INTELLECTUAL PROPERTY ADMINISTRATION, LEGAL DEPT., P.O. BOX 7599, M/S DL429, LOVELAND, CO, 80537-0599, US

(21) Appl. No.: 09/770,892

(22) Filed: Jan. 26, 2001

(51) Int. Cl. G08G 1/095

(52) U.S. Cl. 340/907; 340/909

(57) ABSTRACT

Luminaire for a traffic control system using light emitting diodes, in which a first group of light emitting diodes operate during normal operation, and a second group of light emitting diodes operate from a backup power source during power failures.

### BACKGROUND OF THE INVENTION

1. Field of the Invention

The present invention pertains to the field of vehicular traffic control, and providing backup traffic control in the event of power failure.

2. Art Background

As the volume of vehicular traffic continues to increase, safe and efficient traffic flow is increasingly dependant on traffic control devices to regulate the safe and efficient flow of vehicles at intersections. Traffic control devices range from simple static signs to electrical traffic signals which may be interconnected with sensors and automation systems. The actual device used at an intersection is a function of factors such as traffic density, intersection complexity, and the existence of unique safety hazards at the particular intersection.

Intersections with high vehicular flows almost always use electrical traffic lights, allowing traffic to move in a given direction for a predetermined amount of time. Advanced systems adapt the relative timings of the signal to accommodate varying traffic densities, and may be coordinated in their operation with other traffic signals in the area. As long as the system functions properly, traffic lights have a proven track record of operating safely, and their operation is almost universally understood by vehicle operators.

Failure of traffic lights is most often caused by failure of the electrical supply to the system, such as in blackouts, storms, and the like. Without a source of electricity to operate the lights, the signals remain dark for all approaches to the intersection. In this event, traffic laws require that vehicle operators treat the intersection as an all-way stop—that is, each non-operative signal is treated as a stop sign.

There are serious drawbacks to this system. First, although written into law, vehicle operators are often perplexed by the non-operational status of a failed traffic light, and do not know how to properly treat the intersection. Second, and perhaps more importantly, during periods of darkness or storms, it is often difficult to see the traffic control device, as the surrounding area is dark or obscured. This leads to a very hazardous situation, as vehicle operators unfamiliar with the area may not know of the presence of a failed traffic light.

What is needed is a method of signaling vehicle operators of the presence of an intersection controlled by a traffic light during periods of power failure, and a method to instruct these vehicle operators to treat the intersection properly.

### SUMMARY OF THE INVENTION

Light Emitting Diode (LED) luminaires used in traffic control signals are adapted to flash in the event of power failure. Backup power is provided and the traffic signal controller modified to sense loss of mains power and provide backup power to LED luminaires, which are adapted to flash, powered by the backup power source. Flashing operation may be synchronized.

### BRIEF DESCRIPTION OF THE DRAWINGS

The present invention is described with respect to particular exemplary embodiments thereof and reference is made to the drawings in which:

FIG. 1 shows a traffic controller,

FIG. 2 shows an LED luminaire,

FIG. 3 shows an LED luminaire according to the present invention,

FIG. 4 shows a second embodiment of an LED luminaire according to the present invention,

FIG. 5 shows a third embodiment of an LED luminaire according to the present invention, and

FIG. 6 shows a fourth embodiment an LED luminaire according to the present invention.

### DETAILED DESCRIPTION

The most common method of marking a controlled intersection to be treated as a stop-and-proceed intersection is the use of an octagonal red “stop” sign. An alternative method is the use of a flashing red traffic light. Although used infrequently due to higher cost as compared to a fixed stop sign, the meaning of a red flashing traffic light is well known to the public. Traditional red—amber—green traffic lights are commonly used to control intersections and are well understood, if not universally obeyed. While traffic laws require that drivers treat a nonoperating traffic light as a stop-and-proceed intersection, this may be confusing to vehicle operators, or not noticed. Therefore, if red traffic lights at an intersection could be made to flash when ordinary power were interrupted, the desired effect would be achieved.

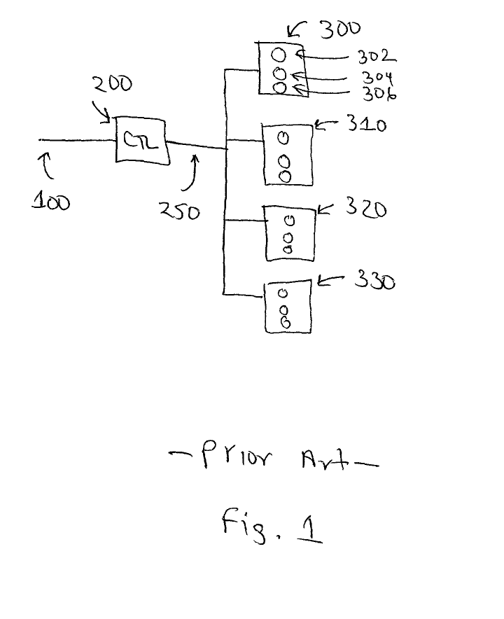

Traditionally, traffic lights have used incandescent filament bulbs with color filters. Traffic controllers, at first based on mechanical timers and relays, and now commonly microprocessor controlled, switch power line voltage, usually 120 Volts AC, to the incandescent filament bulbs to cause them to illuminate. As shown in FIG. 1, main power line 100 powers traffic controller 200, which sequences power to light heads 300, 310, 320, and 330. Light head 300 contains colored lamps in the traditional sequence, red 302, amber 304 and green 306. More advanced controllers make use of traffic sensing devices, and may be interconnected with other signals to manage traffic flow through large complex intersections, or over an area.

Recent developments in semiconductor light generation have resulted in highly efficient light emitting diode (LED) based luminaires for use in traffic signals. Instead of relying on incandescent filaments and color filters, these luminaires use LEDs to generate light based on hole-electron recombination in semiconductors. The result is a highly reliable, very efficient source of light. While red, amber, and green LED luminaire assemblies are available, red is the predominant color deployed, as red LED light sources provide the greatest improvement in efficiency and operating lifetimes over incandescent filament sources.

Backward compatibility with existing infrastructure requires that each red LED luminaire operate off the standard 120 VAC mains power source used to power incandescent sources. Since LEDs are low voltage DC devices, LED based luminaires incorporate power conversion modules known to the art to transform the input alternating current into the steady direct current necessary to drive the LEDs. Integrated within this power conversion block are circuits to keep light output within acceptable limits over variations in temperature, LED aging, input power, and so on. The light emitting portion of the luminaire consists of a plurality of LEDs, usually arranged in a number of series strings connected in parallel. Individually, LEDs are low voltage devices, producing optimum light output with a voltage drop of a few volts, depending on the LED material. Connecting LEDs in series strings allows for a higher operating voltage for each string. Operating a number of strings in parallel reduces the effect of the failure of a single LED on the operation of the overall device.

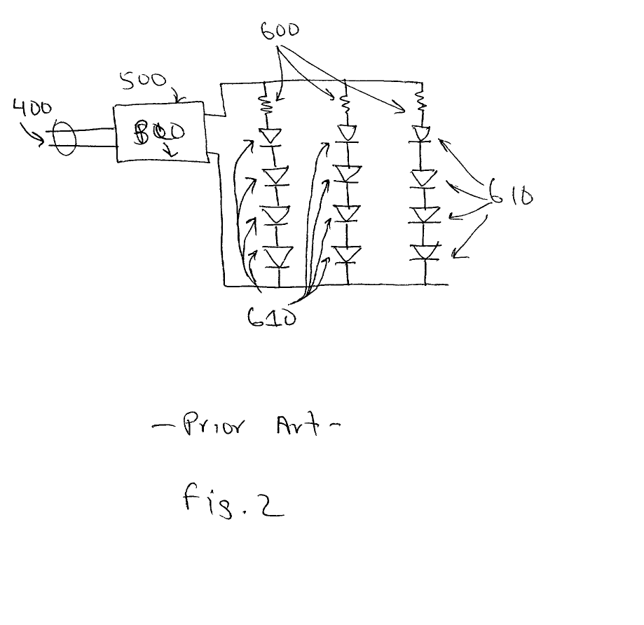

Such an LED luminaire as known to the art is shown in FIG. 2. Power input 400 provides power to power conversion module 500. Power input 400 may be in the form of a common connector such as the Par-56 2-prong lamp connector, or the General Electric 3-prong lamp connector. Wire connections may also used for power input 400, reducing reliability problems introduced by common lamp bases. Power conversion module 500 provides power to series connected strings of LEDs 610. Power conversion module 500 is typically a switch-mode converter which takes AC input 400 and converts it to low voltage DC suitable for driving the LEDs 610, and may also provide compensation for maintaining relatively uniform light output over variations in temperature and over the life of the LEDs. The number of LEDs in a string, and the number of strings depends on factors such as the operating voltage of each LED, LED size, desired output voltage of conversion module 500, and the like. Resistors 600 serve to equalize load over multiple strings of LEDs. Electronic means such as programmable current sources may also be used instead of resistors 600.

Typical LED luminaires include the model 75-0210 from LumiLeds, a joint venture of Philips Lighting and Agilent Technologies, which integrates power converter 500 and LEDs 610 into a unit designed to replace incandescent devices. Other companies producing LED luminaires include Dialight Corporation, and General Electric.

As used herein, a luminaire may only comprise the light emitting diode assembly 610 and the requisite optics, with power converter 500 placed remotely to the luminaire. By providing power converter 500 and LEDs 610 in a combined luminaire, “drop-in” replacement of incandescent devices is facilitated.

The present invention takes advantage of the inherent high efficiency of LEDs, their ability to function on relatively low voltages, and their ability to be cycled or flashed repeatedly without degradation. Where there is a noticeable lag between power being applied to an incandescent source and light being emitted, light emission from LEDs is virtually instantaneous. Rapid cycling of an incandescent source greatly reduces its operating life due to the strain placed on the filament. In contrast, flashing of LEDs does not result in a significant decrease in operating life.

LED flashing circuits are known to the art. A typical LED flasher is the LM3909 integrated circuit from National Semiconductor Corporation. The LM3909 also provides a voltage boost. Low duty-cycle bistable multivibrators may also be used. The average current drain of such a flasher is therefore very low, while producing brief but bright flashes of light.

In the present invention, a plurality of LEDs in the luminaire are adapted for flashing, powered by a backup power source. While all LEDs making up the luminaire may be flashed, using a subset is preferred. This subset may be included in the normal operation of the luminaire, or may be independent from such normal operation.

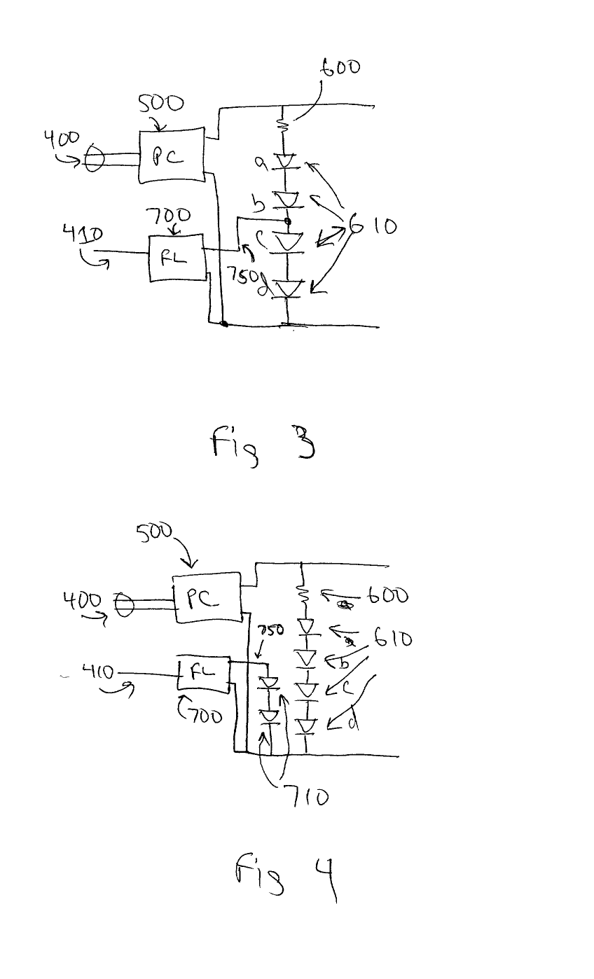

FIG. 3 shows a first embodiment of the present invention. During normal operation, power input 400 supplies power converter 500, driving LEDs 610 through ballast resistor 600. Only one string of LEDs is shown. Also present is flashing input 410, providing power to flashing circuitry 700. Output 750 of flashing circuitry 700 causes LEDs 610c and 610d to flash. Upon power failure to a traffic control device containing the LED luminaire of FIG. 3, backup power is switched to flashing input 410, causing LEDs 610c and 610d to flash. Two LEDs are shown for flashing operation as an example only; the actual number of LEDs chosen for flashing operation will depend on design decisions such as the light level required. The flashing technique herein described could be applied to all LEDs in the luminaire, as well as to a subset.

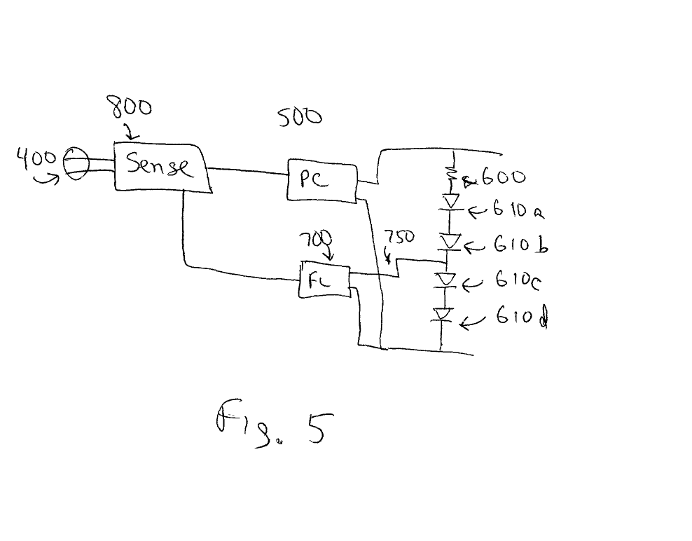

While the operation of flasher 700 is known to the art, for example using a low duty-cycle bistable multivibrator, or an architecture similar to the National Semiconductor LM3909 integrated circuit, additional functions may also be performed. In cases where a number of luminaires are used, it may be desirable to have them flash in a synchronized manner in emergency conditions as described herein. This may be accomplished by impressing a synchronization signal, for example a high-frequency burst, for example, 50 KHz, on input 410, to synchronize the flashing operation of all luminaires in a traffic control cluster. In such operation, flasher 700 operates in free-running mode in the absence of a synchronizing signal, but responds to the synchronizing signal when present, so that all luminaries in the system receiving the synchronizing signal flash together.

Where FIG. 3 shows a subset of the LEDs in the luminaire used during flashing operation, FIG. 4 shows a separate group of LEDs used. In FIG. 4, separate LEDs 710 are shown connected to the output of flasher 750.

The embodiment of FIG. 3 suggests that all LEDs 610 are of the same color, for example, red. The embodiment of FIG. 4 need not share this construction. For example, LEDs 610 used for normal luminaire operation may be amber or green in color, and LEDs 710 for flashing operation may be red. This allows the construction and deployment of a luminaire which has a primary color for normal operation, yet flashes a secondary color in backup operation.

The embodiments shown in FIGS. 3 and 4 may be constructed as single modules, containing power converter 500, flasher 700, and LEDs 610 (and 710), the control and flashing elements may be separated, for example, integrated into traffic controller 200 of FIG. 1.

Where the embodiments of FIGS. 3 and 4 are constructed as single modules, the necessity for running a separate input 410 from the luminaire to traffic controller 200 of FIG. 1 poses a significant expense of the luminaire is to be used as a drop-in replacement for incandescent sources, as an additional wire must be run from traffic control head 300 containing the luminaire to traffic controller 200.

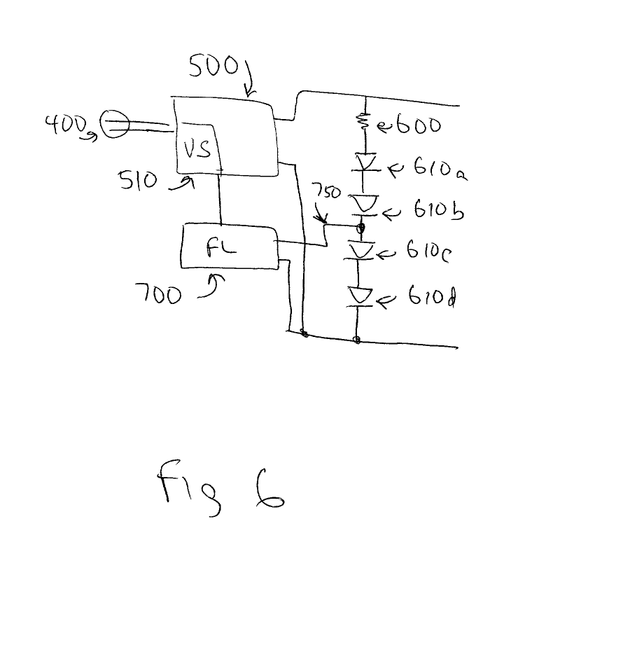

The embodiment of FIG. 5 eliminates this requirement by introducing sense module 800. In normal lurninaire operation, nominal AC power (120 volts) is applied to power input 400. This is sensed by sense module 800, which supplies power converter 500, operating LEDs 610. In the event of a power failure, low voltage DC, typically in the range of 6 to 48 volts DC, is placed on power input 400. Sense module 800 activates flasher 700, which flashes LEDs 610c and 610d.

While FIG. 5 shows LEDs 610c and 610d, a subset of LEDs 610, used for flashing operation, the LED embodiment of FIG. 4, using a separate group of LEDs 710 is also applicable.

This sensing arrangement, switching between normal and flashing modes of operation, may be implemented in many ways. FIG. 5 shows an example of sensing input voltage levels on input 400, and activating the appropriate circuitry, either power converter 500 or flasher 700. The sensing function may be accomplished by power converter 500, for example by inhibiting flasher 700 when the power converter input voltage is above a preset limit. This is shown in FIG. 6, where power converter 500 includes voltage sensing circuitry 510. In a switchmode power supply, this may be part of the startup circuitry, inhibiting startup until the input voltage on input 400 is greater than a predetermined level, for example 60 to 80 volts for a nominal 120 VAC input. When the input voltage 400 is below this level, flasher 700 is activated.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. A traffic control luminaire using a plurality of light emitting diodes, the luminaire having a first operating mode in which a first group of light emitting diodes are illuminated, and a second operating mode in which a second group of light emitting diodes are illuminated.

2. The luminaire of claim 1 where the first and second groups of light emitting diodes contain common members.

3. The luminaire of claim 1 where the first and second groups of light emitting diodes do not contain common members.

4. The luminaire of claim 3 where the first group of light emitting diodes emits a different color than the second group of light emitting diodes.

5. A traffic control luminaire using a plurality of light emitting diodes, the luminaire having a first operating mode in which a first group of light emitting diodes provide steady illumination, and a second operating mode in which a second group of light emitting diodes flash.

6. The luminaire of claim 5 where the first and second groups of light emitting diodes contain common members.

7. The luminaire of claim 5 where the first and second groups of light emitting diodes do not contain common members.

8. The luminaire of claim 7 where the first group of light emitting diodes emits a different color than the second group of light emitting diodes.

9. A traffic control luminaire comprising:
a first group of light emitting diodes,
a second group of light emitting diodes,
a power input for receiving power to the luminaire,
power conversion means connected to the power input for powering the first group of light emitting diodes to provide steady illumination,
flashing means connected to the power input for powering the second group of light emitting diodes to provide flashing operation, and
sensing means connected to the power input, the power conversion means, and the flashing means, the sensing means responsive to the power input and causing the power conversion means to operate in a first operating mode, and the flashing means to operate in a second operating mode.

10. The luminaire of claim 9 where the first and second groups of light emitting diodes contain common members.

11. The luminaire of claim 9 where the first and second groups of light emitting diodes do not contain common members.

12. The luminaire of claim 9 where the first group of light emitting diodes emits a different color than the second group of light emitting diodes.

13. The luminaire of claim 9 where the flashing means further comprises synchronization means responsive to a synchronization signal passed on the power input, synchronizing the flashing operation of the second group of light emitting diodes to the synchronization signal if present.

14. The luminaire of claim 9 where the sensing means selects for operation either the power conversion means or the flashing means depending on the state of the power input.

15. The luminaire of claim 9 where the sensing means selects the operation of the power conversion means when the voltage on the power input exceeds a threshold voltage.

16. The luminaire of claim 9 where the sensing means selects the operation of the flashing means when the voltage on the power input is below a threshold voltage.

17. A traffic control system comprising:
a plurality of luminaires, at least one light emitting diode luminaire using a plurality of light emitting diodes, the light emitting diode luminaire having a first operating mode in which a first group of light emitting diodes are illuminated, and a second operating mode in which a second group of light emitting diodes are operated,
a primary power input for powering the traffic control system from an external source,
a secondary, backup power source built into the traffic control system,
control means connected to the luminaires, the primary power input, and the backup power source, for illuminating luminaires in sequence,
the control means operating the luminaires in a first operating mode when primary power is available from the external source, causing the first group of light emitting diodes in the light emitting diode luminaire to operate, and
the control means operating the luminaires in a second operating mode when primary power is not available from the external source, supplying power from the backup power source to the light emitting diode luminaire to operate the second group of light emitting diodes.

18. The traffic control system of claim 17 where the first and second groups of light emitting diodes contain common members.

19. The traffic control system of claim 17 where the first and second groups of light emitting diodes do not contain common members.

20. The traffic control system of claim 17 where the first group of light emitting diodes emits a different color than the second group of light emitting diodes.
